(19) United States
(12) Patent Application Publication
(10) Pub. No.: US 2018/0139219 A1
(43) Pub. Date: May 17, 2018

(54) Cyber Security: A system to monitor home Wi-Fi networks

(71) Applicants: Ashok Sabata, Freehold, NJ (US); Karl Baumgartner, Lausanne (CH); Thierry Jayet, Lausanne (CH); Joseph Lawlor, Holmdel, NJ (US); Octavian Cheiaru, Bucharest (RO)

(72) Inventors: Ashok Sabata, Freehold, NJ (US); Karl Baumgartner, Lausanne (CH); Thierry Jayet, Lausanne (CH); Joseph Lawlor, Holmdel, NJ (US); Octavian Cheiaru, Bucharest (RO)

(21) Appl. No.: 14/964,650

(22) Filed: Dec. 10, 2015

(51) Int. Cl. H04L 29/06; H04W 24/08

(52) U.S. Cl. CPC H04L 63/1425; H04W 84/12; H04L 63/0428; H04W 24/08

(57) ABSTRACT

Consumers have a general awareness of cyber threats and its prevalence but most are completely unaware that their own computer systems are below the standard for keeping them safe. Systems on the internet are now exposed to cyber-attacks by sponsored and unsponsored hackers seeking to exploit vulnerabilities known to exist in applications and operating systems. A typical home user has a simple network with multiple devices connected to the internet but does not have an awareness of activity on their network. There has been a long felt need for a wireless monitoring solution that is affordable, made for homes and offices, monitors remotely, continuously and uses a plug and play type of accessory that does not require modifying the existing network used in homes and offices and does not require outsourcing of the cyber security threat and protection.

### REFERENCES CITED

U.S. patent DOCUMENTS

| | | |
|---|---|---|
| 20140259147 A1 | September 2014 | L'Heureux et al. |
| 7,042,852 B2 | May 2006 | Hrastar |
| 7,058,796 | June 2006 | Lynn et al. |
| 8,069,483 B1 | November 2011 | Matlock |
| 8,934,495 | January 2015 | Hilton et al. |
| 20100162399 A1 | June 2010 | Sheleheda et al. |

### BACKGROUND OF THE INVENTION

The present invention and the various embodiments thereof, relate to an affordable system to monitor networks communications, more particularly, wireless networks used in homes and offices with the goal of improving cybersecurity by increasing awareness of activities in the network, detecting intrusions and preventing unauthorized access.

The building blocks of the Internet were engineered such that, virtually all computers, people, and institutions with access to the Internet could be trusted to behave themselves. The growth and widespread use of the internet has exposed its vulnerabilities. While consumers have heard about cyber crimes and its prevalence, most are completely unaware that their own computer systems are below the standard for keeping them safe. Systems on the internet are now exposed to cyber-attacks by sponsored and unsponsored hackers seeking to exploit vulnerabilities known to exist in applications and operating systems. Once a virus or hacker manages to get past the firewall, all of the devices protected by that firewall, become an easy target for attack and can be used to attack others. Oftentimes the cause for the breach of the network is the user opening email attachments that are malicious files or visiting sites that download malicious files to the user's devices.

The computer network infrastructure relies upon the implementation of standard local area network (LAN) protocols, including Ethernet, that permit organizations to construct computer networks comprised of multiple computing devices connected to one another via hardwire connections for the high speed exchange of data using relatively inexpensive network connection devices for the purpose of sharing information and data over the LAN. Until recently, LANs required that the computing devices be interconnected using physical hardwired connections or network adapters forming the network infrastructure.

Developments and commercialization of wireless communications has now carried over to the LAN. Wireless communications in a wireless LAN are typically implemented using radio transceivers on computing devices, or peripherals, and wireless access points (WAPs) that are connected via a physical hardwire infrastructure to the network backbone comprised of other computers, servers, and peripherals. Devices such as laptop, desktop computers, mobile devices such as smart phones and tablets are equipped with a wireless transceiver which communicates with the WAP.

To monitor these networks many diagnostic tools and many software solutions have been developed either as an application on an ordinary computer, or as an integrated hardware appliance. The software solutions require the network data that is typically accessed via a network hub or a TAP (test access port) or other hardware appliance that is inline between the wireless access point and the wired network creating a copy of packets going through it for analysis.

U.S. Publication No., 20140259147 A1, entitled “SMART ROUTER”, discloses, a ‘smart router’ that monitors and controls the network traffic similar to corporate network controllers. U.S. Publication No., 20100162399 A1 similarly refers to similar devices to detect malware and botnets. Recently Google released a smart router called the “Hub” that represents this new class of devices. Drawbacks with the smart router is that it would require replacing partially or completely existing network, they do not monitor WiFi packets only packets that reach the access point and they are expensive.

U.S. Pat. No. 7,042,852, and U.S. Pat. No. 7,058,796 disclose intrusion detection devices that actively interact with the intruder in different ways to defend the wireless LAN such as acting like a compromised access point or by transmitting a jamming signal, a signal to introduce CRC errors, or a signal to make it more difficulty to break encryption used by the network. The current invention does not do any of that.

U.S. Pat. No. 8,069,483 B1 discloses a device for and method of detecting intrusion into a wireless network that includes a configuration file, a rules files, a main processor, a set packet processor, an initialize preprocessor, a parse rules file, an interface thread unit, a process packet unit, a decoder, a preprocess connected to the process packet unit; at least one preprocessor consisting of a rogue access point and transmit channel preprocessor, a NETSTUMBLER preprocessor, a MAC spoofing preprocessor, a DEAUTH flood preprocessor, an AUTH flood preprocessor, a rogue client preprocessor, a bridged network preprocessor, a rogue client valid access point preprocessor, valid client rogue access point preprocessor, an ad-hoc network preprocessor, a wrong channel preprocessor, a cloaking policy violation preprocessor, an encryption policy violation preprocessor, and a null SSID association policy violation preprocessor, and a detect unit. The current invention is much simpler, easy to setup by a novice user, affordable and designed for home and office use.

Wireless monitoring devices called WiFi sniffers have been used for variety of purposes: to debug and troubleshoot wireless network problem that relate to specific computers or devices having difficulty joining the wireless networks as well as to detect unauthorized devices joining the wireless network. Some experts have used these sniffers in corporate networks by connecting them to the network controller, via the ethernet port on the sniffer, then to a server to authenticate the WiFi device trying to join the network; sometimes a WiFi device is used as a scanner in conjunction with a WIDS (wireless intrusion detection system) architecture. Here again the drawback of all these devices are that they are intrusive and the cost of the solution as well as the purpose of such sniffing is for authenticating only but not to continuously monitor the network, its health, its performance as well as intrusions, which is normally done in an expensive network controller in a typical corporate network.

In recent years several companies have released devices to monitor networks in homes. These devices connect directly to the routers or access points and have the network traffic flowing through them. The devices have some software on them to detect events. Many of these devices do not connect to the cloud where more processing of the network data takes place. There are several challenges with this approach. Firstly, connecting to the home router or access point can be problematic as there are many vendors for routers so it is possible that some of these routers will have setup and compatibility issues that will require advanced troubleshooting for proper setup. A novice user will always have a problem with any device that requires sophisticated setup. Secondly, these devices, because they are connected directly to or inline with the network, may introduce vulnerabilities or network performance degradation due to their own software or hardware implementations and limitations. Thirdly, the manufacturers of these devices that do have some cloud services operate similar to current anti-virus software companies wherein, they take control of the machine and just automatically update the software, and the only interaction with end user is for annual renewal of the software. Finally, there are so many malware variants continuously evolving and being spread throughout the internet that it is no longer possible for traditional anti-virus to recognize and prevent infections from this malware thereby rendering anti-virus ineffective in protecting the user. Further, these anti-virus applications do not improve or increase the user awareness of threats to their security and privacy.

As evidenced by the effort of previous workers, there has been a long felt need for a wireless monitoring solution that is affordable, monitors remotely, continuously and uses a plug and play type of accessory that does not require modifying the existing network used in homes and offices and does not require outsourcing of the cyber security threat detection and protection. By way of example, the invention has been applied to a computer networking environment based upon the IEEE 802.11 family of standards, commonly called “WiFi.” But it would be recognized that the invention has a much broader range of applicability such as Bluetooth, and others.

### BRIEF SUMMARY OF THE INVENTION

It is the object of the current invention to monitor networks communications in an affordable and user friendly manner; more particularly, monitor continuously and in real time, wireless networks used in homes and offices using a microcomputer as a sniffer, that sniffs wireless packets, combines robust alerting based on analysis generated by a central system, and makes the results of analysis accessible to the user through a mobile application. Methods are disclosed for decrypting the packets. The sniffer disclosed herein, processes the packets in to NetFlow data and other network activity data that is then stored onboard until it pushes the data on to the cloud through an API. As further described, a central cyber processing unit (CCPU) in the cloud is used to processes the data, aggregate them using analytical tools into information that is then stored in an online database. The user accesses the information on a smartphone or tablet.

In one embodiment, a method to increase cyber security wherein data is collected online in the cloud from a distributed network of sniffers. Rules and filters are created by analyzing the collected data. The filters and rules disclosed herein, are applied by the CCPU as well as by the sniffer locally. Positive results from a rule matching are sent to the user as alerts on a smart phone or tablet through an APP. As further described, these rules are a combination of preset rules, user defined rules, and CCPU recommended rules. Rules may include but are not limited to such things as a new device joining the network, malicious websites being visited by a user, a device dropping offline, network speed decreasing, Wifi quality including signal strength, connection persistence and packet retransmission.

In an additional embodiment, the CCPU remotely stores the collected data from the sniffer, creates aggregates and conducts more sophisticated interrogations against the historical data and provides actionable information in the form of reports and alerts to the user through the APP. As further described this sophisticated interrogation is accomplished through analytical tools used by the CCPU to identify patterns of normal, healthy behavior and then comparing those to the data collected on your WiFi network to identify anomalies. In addition, this security alerting system is particularly advantageous for it also allows users to share security alerts for their WiFi networks to a group of other users of their choice.

In a further embodiment, the method can increase cyber threat awareness and improve cyber security through a learning process that fuses data from several sources including the user's local network, the collective community of users networks, with global cyber threats that include open source cyber threat intelligence such as blacklists, virus signatures, scanning activity, communication signatures; applying a myriad of analytical tools including statistical analysis, machine learning, predictive analytics; iteratively to create new rules, alerts, and reports that are passed to the distributed network of sniffing devices that work in concert with one another through the CCPU for the benefit of each user's WiFi network defense; rules are generated by the CCPU and recommended to the users along with a corresponding ranking that combines other users' ratings of the rule, the relevance to the particular user's network and the popularity of the rule. Further, the users can select which of the presented rules to implement on their system. As further described, the process of learning, creating rules, distribute rules, measuring the rules effectiveness, is repeated.

In still further embodiments, a method to directly sniff remotely so as to allow an expert to debug network problems without being present locally; a particularly useful solution for novice users to take help of experts.

Other features and variations can be implemented, if desired, and related systems and methods can be utilized, as well.

### BRIEF DESCRIPTION OF THE DRAWINGS

It is noted that the appended drawings illustrate only exemplary embodiments of the invention and are, therefore, not to be considered limiting of its scope, for the invention may admit to other equally effective embodiments. For the present invention to be clearly understood and readily practised, the present invention will be described in conjunction with the following figures, wherein:

FIG. 1 is a diagram illustrating the hardware of the sniffer;

FIG. 1a is a diagram illustrating the software architecture of the sniffer;

FIG. 2 is a diagram of the components the Central Cyber Processing Unit in the cloud;

FIG. 3 is a diagram of the APP functions with data flow between the APP and CCPU;

FIG. 4a is a sketch of the APP on a tablet showing data traffic between the network and the world;

FIG. 4b is a zoomed in view of 4a showing data traffic within the network; and

FIG. 5 is a diagram of the learning engine running on the CCPU.

### DETAILED DESCRIPTION OF THE INVENTION

While the present invention will be described more fully it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

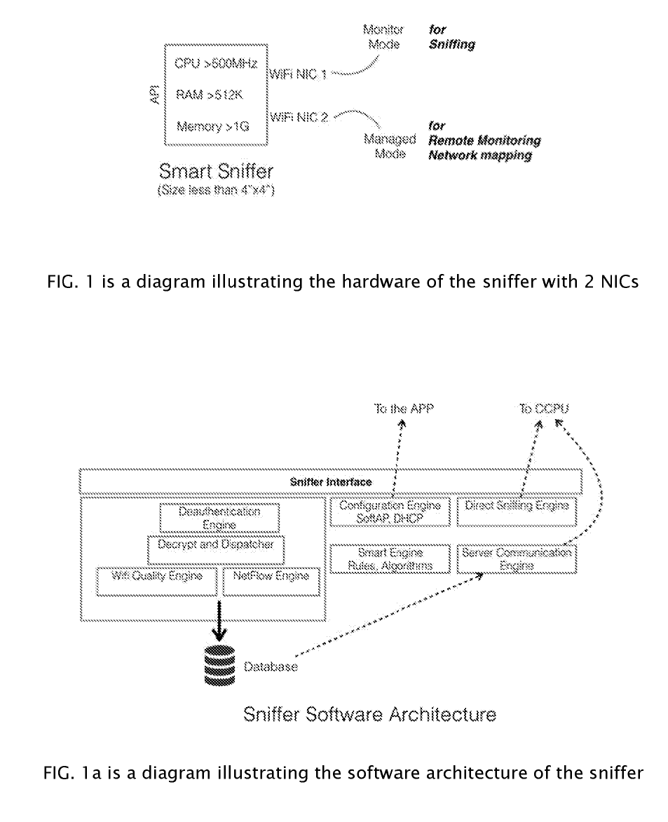

First briefly in overview, the present invention and the various embodiments thereof, relate to an affordable system to monitor networks communications, more particularly, wireless networks used in homes and offices with the goal of improving cyber security by increasing awareness of activities in the network, detect intrusion and preventing unauthorized access. The present invention improves on the prior art by using a smart sniffer that includes a microcomputer that sniffs the network traffic and processes the data on the sniffer locally. FIG. 1 illustrates the design of the portable sniffer; it includes two WiFi chips or NICs (network interface cards) with a microcomputer which is a low cost embedded device that runs a linux operating system on it that makes it a smart sniffer that is affordable for homes and small businesses; it can be easily configured by the user by making it into a soft access point so the user can directly connect it to a smart phone and use an APP to communicate with it. It should be noted the raspberry pi described herein is an example of an embedded microcomputer. The prior art uses expensive enterprise devices that include pre-processors, processors, computers used locally that require significant maintenance.

The WiFi NICs can operate in one of the following 6 modes: Master mode as in an access point, Promiscuous mode or managed mode where it is a client, Ad-hoc mode, mesh mode, repeater mode, and the monitor mode. Most packet sniffers first authenticate with the access point then use the WiFi NICs in the promiscuous mode. In the present invention, one of the WiFi NICs is used in the monitor mode that allows passively sniffing packets without joining or associating with an access point. The other WiFi NIC joins the network in the managed mode by authenticating using the SSID and password. It then passes the SSID and password to local processor enabling decryption of the packets sniffed by the WiFi NIC in the monitor mode. In the prior art standard tools like Wireshark on a PC with sniffers like Airpcap sniff in the monitor mode to analyze network problems; alternatively for continuous monitoring, sniffers in the promiscuous mode in combination with servers are used to monitor network packet traffic. The use of multiple WiFi NICs makes it possible to monitor continuously and remotely, while still passively sniffing packets in the network.

In an embodiment, a method to decrypt the packets passively even if some packets are dropped which is common; for decryption the sniffer needs the handshake packets, typically 4 packets are used during handshake, between devices in the network and the access point; when the sniffer misses these packets because of congestion, signal strength or other reason, the sniffer uses the other WiFi NIC to de-authenticate the as described device thereby forcing it to rejoin the network; during rejoining, the sniffer can make another attempt to catch the handshake packets. In addition, the sniffer's ability to de-authenticate devices can be used to remove unauthorized devices from the network.

In an embodiment, the as described smart sniffer is used for continuous monitoring of the network traffic by capturing the full contents of all network traffic and processing this traffic to extract the NetFlow data on the sniffing device. The NetFlow data is combined with other network activity data collected by the sniffer and then pushed out to the cloud through an application programming interface (API).

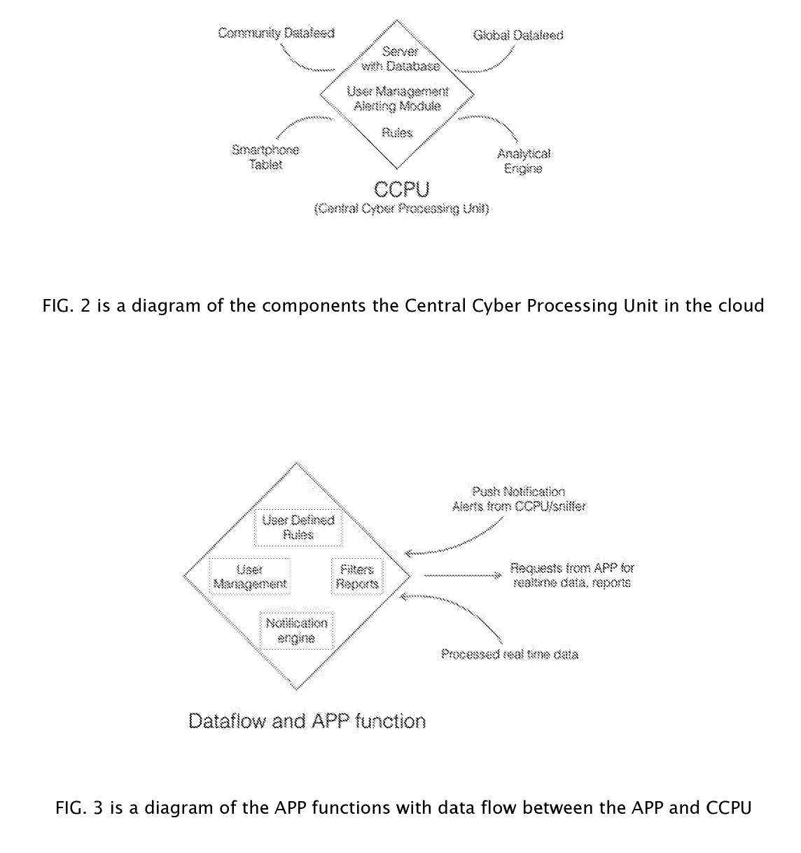

FIG. 2 is a diagram of the components of the CCPU; the system in the cloud includes the CCPU with interfaces for input and output of data. The CCPU includes a user management and information control system that allows the user to configure selective access to the information which gives control to the user to decide who can see what information. The CCPU collects and processes the data from an individual sniffer and passes the pertinent information to the individual's mobile device, such as smartphone or tablet; the CCPU allows the individual to conduct monitoring of their WiFi network continuously, in real time from anywhere. Pertinent information includes actionable information that is consumable and understandable by the everyday novice user, and awareness of activity on their WiFi network; awareness includes but is not limited to how many devices are in the network, whose device is on the network, bandwidth used by each of the devices, ports and protocols used, IP and MAC addresses, time of activity, websites visited by all devices, active or inactive, associated currently or previously with their monitored WiFi network. In addition, the monitoring system allows users to share and distribute awareness information about their WiFi networks to a group of other users of their choice; that makes it possible for friends and family to share network security as well as help novice users.

In the prior art the systems are focused on detecting intrusion by using tools such as SNORT that require significant resources and expertise making it impossible for a home user or a small business to use the solution; the current invention makes the user aware of network activity by addressing the problem of cost and user knowledge by creating an architecture that is affordable and does not require an expert to interpret the data. In an embodiment of the invention the network activity is converted to NetFlow data and moved to the cloud and stored as time series data for further processing; aggregating the information then moving the data to the smart phone or tablet for the user to be able to view in real time how the network resources are being used across devices in the network; allowing the user to create rules on the APP to notify them; filters to view a particular device's activity, port activity, DNS activity, band width usage and similar parameters. FIG. 3 is a diagram of data flow between CCPU and the smart phone; the APP functions are also illustrated. In addition to user defined rules, preset rules are already in place; preset rules such as new devices joining the network, devices with poor WiFi quality including signal strength, connection persistence, packet retransmission and many similar rules that are implemented on the CCPU or the sniffer are used to alert the user.

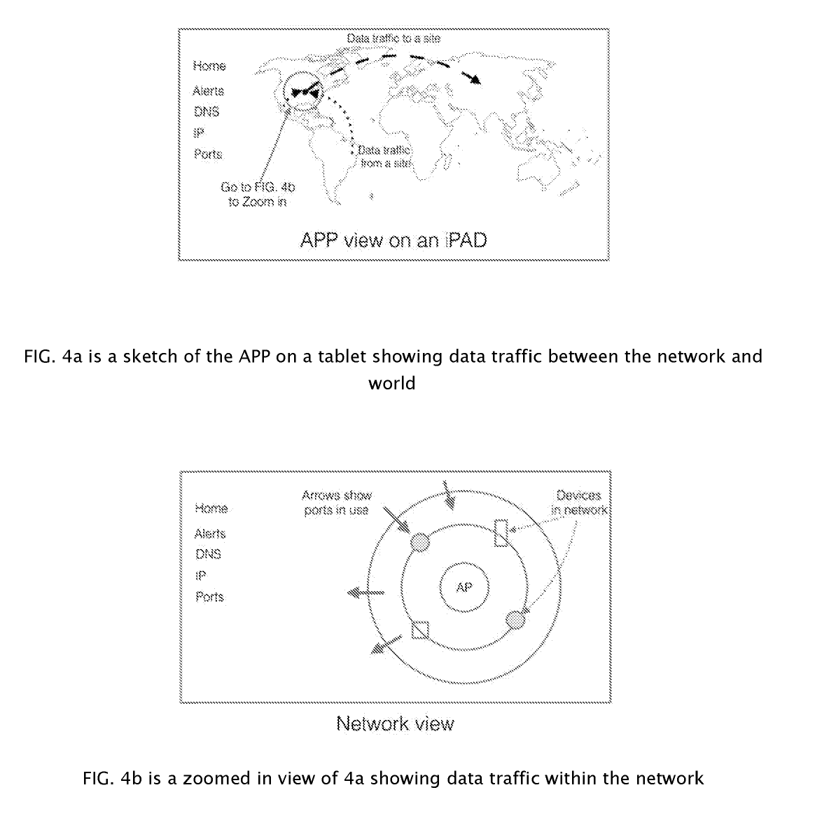

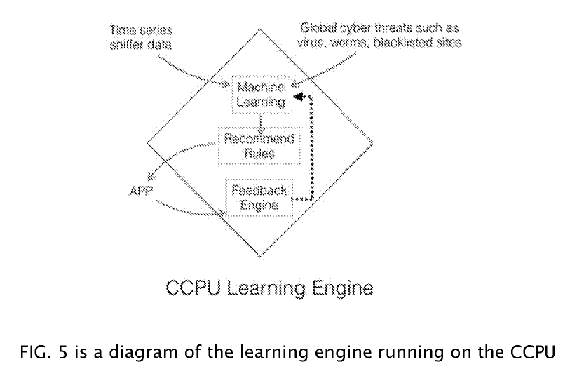

Alerting and push notification in APPs are a common technique by which users are notified. Alarms can be similarly set, for intrusions or spurious network activities, in the APP. To increase the awareness of what is going on in the users network the APP depicts very simple and common sense view similar to what is understood for home security; are all the doors and windows secure, is there an intrusion, are family members leaving or coming in, are they healthy. The analogous behaviour in the world of networks is what ports are open, what sites are being visited, how much of the network bandwidth is used and by who, is the network healthy. FIGS. 4a and 4b is a visual representation of the APP showing an overview of network activity designed for novice users.

As seen in the prior art as well as from devices in the market to analyze networks a myriad of software solutions are available. The available software solutions are expensive and not for novice users. In addition, the internet is flooded with all types of cyber threats and these are increasing. A new approach is being proposed to manage this problem similar to how a human body defends against disease wherein the body's immune system learns from an attack by the virus or bacteria from individual cells that pass on the information to other cells. In an embodiment a method analogous to the body immune system is proposed with the sniffer node first sees anomalous packets and alerts the CCPU which looks at its depository of information and flags the event in case there is no prior experience with the anomaly; further analysis may confirm the anomaly to be a problem that needs alerting the user; spreading the ‘word’ to other sniffers within the community while continuing to track and rank it.

In a further embodiment of the invention a method to generate and distribute rules that novice users can choose to use wherein these recommended rules are generated through an evolutionary process that first fuses data from several sources including the user's local network, the collective community of users networks, with global cyber threats including, but are not limited to, open source cyber threat intelligence such as blacklists, virus signatures, scanning activity, communication signatures; a myriad of analytical tools are applied on these data feeds to create recommended rules that are for sniffers or for the APP on the smart phones and tablets; recommended rules are then distributed to the community of users with a feedback method in place; the users can select which of the recommended rules to implement on their system based on the ranking from other users, its popularity and relevance.

What is claimed is:

1. A system to continuously monitor network communications in a cost effective manner in homes and offices in real time, said system comprising: one or more wireless networks; one or more sniffers each with one or more wireless network interface cards, provisioning, sniffing, connecting to the internet cloud; a processor on the sniffer using a software to extract the information from network data, network activity data related to wireless quality, intrusion related information, network resource utilization data; a storage for data on the sniffer to store processed packet information; an algorithm to alert for network anomalies; application programming interface to pass the processed packet information and alerts for further use by IT systems; a central cyber processing unit in the cloud for remote, continuous monitoring and further processing; an user interface to provide a user near-real time alerts, access and view user's network information from the central cyber processing unit.

2. The system of claim 1 wherein the sniffer is an embedded device that runs a linux operating system on it.

3. The system of claim 1 wherein one or more wireless network interface card is in the monitor mode each sniffing 2.4 GHz WiFi or 5 GHz WiFi or one of the frequencies following 802.15.4 protocol.

4. The system of claim 1 wherein one or more wireless network interface card sniffs bluetooth packets.

5. The system of claim 1 wherein one wireless network interface card communicates via WiFi and runs in the managed mode, connecting to the wireless network being monitored.

6. The system of claim 1 wherein the processor on the sniffer runs an algorithm to decrypt packets.

7. The system of claim 1 wherein the central cyber processing unit manages the users and the alerts to the users.

8. The system of claim 1 wherein the central cyber processing unit aggregates data from multiple sniffers.

9. The system of claim 1 wherein the central cyber processing unit has a time series database to store the information from the sniffer.

10. A method to increase user awareness and monitor activity of one or many devices in a wireless network near real-time, the method comprising: collecting information about activity of devices in the network using one or many sniffers; a central cyber processing unit in the Internet receiving information from multiple sniffers from multiple wireless networks; the cental cyber processing unit merging sniffer information with user preferences, generating reports and alerts for users; a user interface showing remotely and in real time who is on the network, the internet activity of the devices in the network, bandwidth used by the devices, the WiFi quality of the network, intrusion alerts, event alerts as per user preferences and reports from the central cyber processing unit.

11. The method of claim 10 wherein the sniffer has multiple WiFi network interface cards with a processor running linux operating system.

12. The method of claim 10 wherein the user interface is an APP on a smartphone or a tablet.

13. The method of claim 12 wherein the APP has a user management system that controls access to users wireless network information.

14. The method of claim 12 wherein the APP increases the user's awareness of the network by labeling said traffic as threats or normal, showing DNS names of external IP addresses on a map interface, open ports, bandwidth usage and WiFi quality of each device in the network.

15. The method of claim 12 wherein the APP automatically displays information regarding the device name in the wireless network that were read by the sniffer.

16. A method to increase cyber security of devices in a wireless network, the method comprising: a distributed learning system that includes one or more wireless sniffers and a CCPU; the CCPU aggregating global cyber threats with emerging patterns from the collection of sniffers, detecting anomalous traffic from devices in on or more monitored networks, recommending rules to users; an APP to poll the value of recommended rules, and encourage adoption of popular recommended rules; analyze packets remotely to decipher compromised systems and debug network problems.

17. The method of claim 16 wherein the sniffer has two or more WiFi network interface cards with a processor running linux operating system.

18. The method of claim 16 wherein the CCPU is located in the cloud.

19. The method of claim 16 wherein global cyber threats are viruses, trojan horses, worms, blacklisted domains, blacklisted IP addresses, known signatures and emerging patterns that are indicators of threats, vulnerability, and compromise.

20. The method of claim 16 wherein the anomalous traffic detected by the CCPU is the result of malware residing on one of the devises in the network.

21. The method of claim 16 wherein the anomalous traffic detected by the CCPU is the result of an intrusion from unauthorized access in the network.

22. The method of claim 16 wherein the CCPU has a learning engine to come up with recommended rules that are ranked by users.

23. The method of claim 16 wherein the packets are analyzed remotely by an expert using the sniffer in a packet collection mode for the purpose of debugging communication and device problems.

24. The method of claim 16 wherein the CCPU has a learning engine that clusters the emerging patterns of network traffic and labels the clusters as threats or benign.

25. The method of claim 16 wherein the CCPU learns by example by using the expert labeled network traffic patterns as threats to propose similar patterns of traffic as potentially harmful.
